(19) United States
(12) Patent Application Publication
(10) Pub. No.: US 2017/0144077 A1
(43) Pub. Date: May 25, 2017

(54) Modular Balloon Support System

(71) Applicant: Balloon Innovations Inc., Westminster, CO (US)

(72) Inventors: Christopher J. Wicken, Golden, CO (US); Gregg A. Wicken, Boulder, CO (US)

(21) Appl. No.: 14/946,246

(22) Filed: Nov. 19, 2015

(51) Int. Cl. A63H 27/10; G09F 19/00

(52) U.S. Cl. CPC A63H 27/10; G09F 19/00; A63H 2027/1008; A63H 2027/1041; A63H 2027/1075

(57) ABSTRACT

The invention generally relates to a modular balloon support system that may be used to generate customizable geometric balloon clusters and displays that may be used for marketing, promotional, advertising, and decorative displays among others.

### TECHNICAL FIELD

Generally, the inventive technology disclosed herein relates to a novel and unique modular balloon support system. In a preferred embodiment, the invention may be used to create geometric and other patterned balloon displays. Such geometric clusters or constructs may be customizable to generate multiple shapes, designs and configurations for marketing, advertising or even decorative purposes. This inventive technology may be particularly suited for helium-free balloons and other marketing display systems that are positioned outside commercial establishments to attract attention and/or highlight a specific promotion or event. In certain embodiments, such assemblies may mimic the action and presentation of traditional helium balloons and the like.

### BACKGROUND OF THE INVENTION

Traditional external marketing assemblies are commonly employed to promote various commercial or organizational interests as well as events. For example, traditional external marketing devices may include some type of large object, such as signs, placards or novelty attention-grabbing devices that may be placed outside to catch a passerby's attention thereby promoting a certain business or event. In recent years, various inflatable external marketing devices have been deployed as marketing devices to attract public attention. Example of such air-filled based systems may include external balloon systems, as well as large inflatable figures or structures. Despite their use, such large inflatable devices have several drawbacks that limit their uses. First, traditional large inflatable devices are typically expensive and simply not cost effective for most businesses to purchase for a specific promotion or event. As a result, most traditional large inflatable devices must be rented for short periods of time. This also limits the ability to personalize any large inflatable devices for a specific event or promotion.

Second, traditional large inflatable devices must be constantly re-inflated through one or more air pumps and/or blowers. Because of their dependence on such constant re-inflation, use of such large inflatable devices is limited by their access to adequate electrical power to re-inflate the devices. Moreover, the electrical costs can also be prohibitive over a long course of time further limiting the large inflatable devices' ability to be deployed for an extended period of time.

Third, traditional helium-based large inflatable devices are not cost effective. For example, a lack of private sector helium producers, federal regulations and decline in U.S. Federal Helium Reserves have resulted in significant price increases and dwindling supplies of commercially available helium. Much of the available helium gas is currently being diverted to industrial and/or medical uses, such as MRI's, cryogenic preservation as well as scientific applications such as particle accelerators. Under these conditions, it is simply not cost effective to continue production of helium-dependent inflatable marketing systems.

Fourth, such traditional balloon display systems lack inexpensive and easily assembled modular functional elements that allow for the creation of various geometric shapes and arrangements allowing for a variety of public presentations. In addition, such traditional systems are limited in their ability to be positioned, such as from elevated or irregular surfaces. In addition, such traditional systems may be typically suited for only a single environment, such as strictly indoors or outdoors.

Fifth, traditional systems also typically require any corresponding balloon elements to be inflated separately prior to incorporation into a display. Such individual inflation or deflation may limit the number and complexity of the presentation.

As can be seen, there is a need for a single comprehensive solution to the limitations described above. The current invention overcomes these limitations of, and indeed surpasses the functionality of such traditional external balloon assemblies. It is therefore the object of the present invention to provide a simple, versatile, easily-inflatable, modular, cost effective balloon display support system that may be compatible with a variety of attachment surfaces and may be used both inside and outdoors as well as having the ability to be internally and/or externally inflated. In addition, such assembly may be configured to support larger and heavier balloons while still providing the aesthetic appearance and motion of a lighter than air display. Accordingly, the objects of the methods and apparatus described herein address each of the aforementioned problems and goals in a practical manner. Naturally, further objects of the inventive technology will become apparent from the description and drawings below.

### SUMMARY OF INVENTION

The inventive technology may generally include various embodiments of a modular balloon support system. In one embodiment one or more connectors may be secured together and further coupled with a manifold. In one embodiment this manifold may secure one or more balloons through an integral or modular balloon attachment. In some embodiments each manifold may include a valve housing that may hold one or more valves in fluid communication with a balloon attachment through one or more internal airways. In other embodiments, a connector, or series of connectors, may be coupled with a proximal and/or terminal adaptor which may each include a surface attachment position or even a balloon attachment position. The positioning and number of the aforementioned elements may allow for the formation of balloon clusters and/or entire displays having customized shapes, colors and orientations. Such balloon clusters may be secured to a variety of surfaces, whether as a single or plurality of modular elements, allowing further customization. In some instances, seamed and/or seamless helium-free balloons, such as those described in U.S. patent application Ser. No. 14/201,665, (which is incorporated herein in its entirety) may be utilized.

The inventive technology may further include one or more modular manifolds, again having one or more integral and/or detachable balloon attachments that may secure a balloon element. In this embodiment a plurality of manifolds may be coupled together allowing the formation of a customizable balloon cluster. Further embodiments may include a variety of secondary balloon attachments that may be secured with, or coupled to, one or more modular manifolds allowing further customizable balloon clusters and displays.

Additionally, the inventive technology may include a variety of modular external surface mounts. Such mounts may be secured to an external surface and further coupled to one or more manifolds, modular manifolds, secondary balloon attachments or other modular elements described in more detail below. In such embodiments, various customized modular balloon clusters may be positioned in a variety of ways and to a variety of external surfaces.

### BRIEF DESCRIPTION OF THE DRAWINGS

FIG. 1: is an exploded view of a modular balloon support in one embodiment thereof;

FIG. 2: is a modular balloon support coupled with a plurality of balloons in one embodiment thereof;

FIG. 3: is a partially exposed side view modular balloon support coupled with a plurality of balloons in one embodiment thereof;

FIG. 4: is a perspective view of a manifold in one embodiment thereof;

FIG. 5: is a cross-sectional view of a manifold perspective view of a manifold in one embodiment thereof;

FIG. 6: is a front view of two coupled connectors with a manifold coupled to the upper connector with shadowed lines demonstrating that the manifold is rotatable in one embodiment thereof;

FIG. 7: is an isolated terminal connector in one embodiment thereof;

FIG. 8: is a connector coupled with a terminal connector in series with a manifold coupled to the upper connector with shadowed lines demonstrating that the manifold is rotatable in one embodiment thereof;

FIG. 9: is an isolated proximal connector in one embodiment thereof;

FIG. 10: is a proximal connector, three connectors, and a terminal connector coupled in series further coupled with a plurality of manifolds in one embodiment thereof;

FIGS. 11a-d: are multiple views of a modular manifold in one embodiment thereof;

FIGS. 12a-c: are multiple views of an extended modular manifold in one embodiment thereof;

FIGS. 13a-d: are multiple views of a modular balloon support in one embodiment thereof;

FIG. 14: is a modular manifold and external surface mount in one embodiment thereof; and

FIG. 15: is a modular manifold coupled with an external surface mount and a plurality of balloons in one embodiment thereof.

### DETAILED DESCRIPTION OF THE INVENTION

The present invention includes a variety of aspects which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

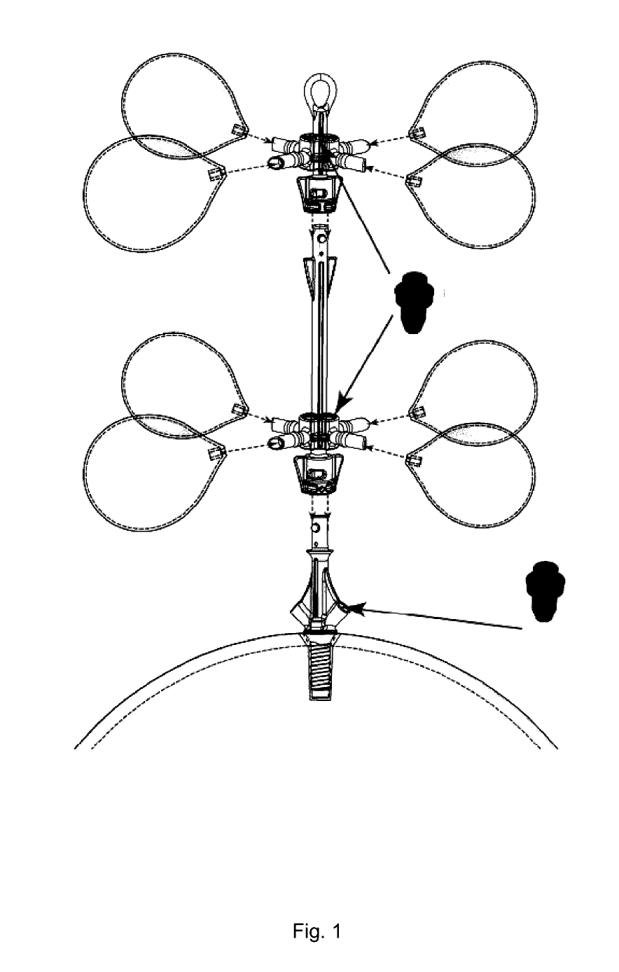

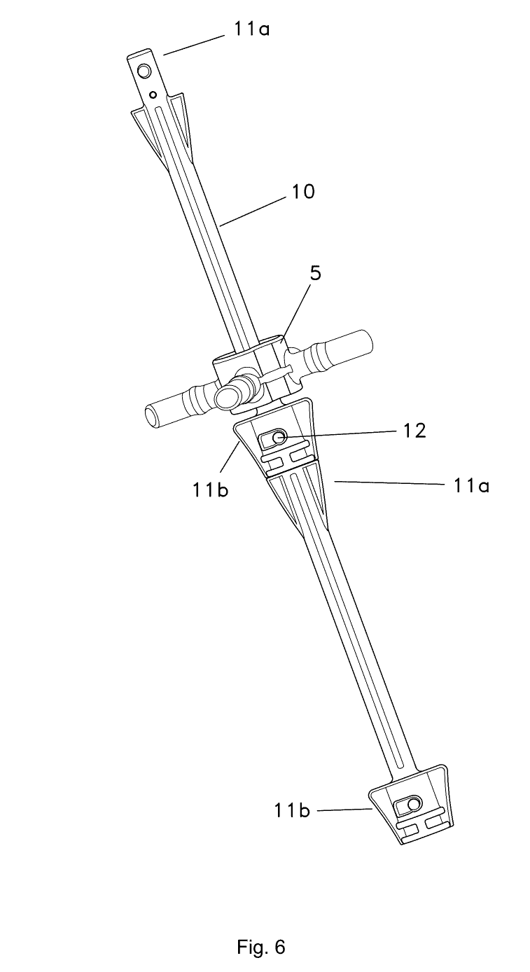

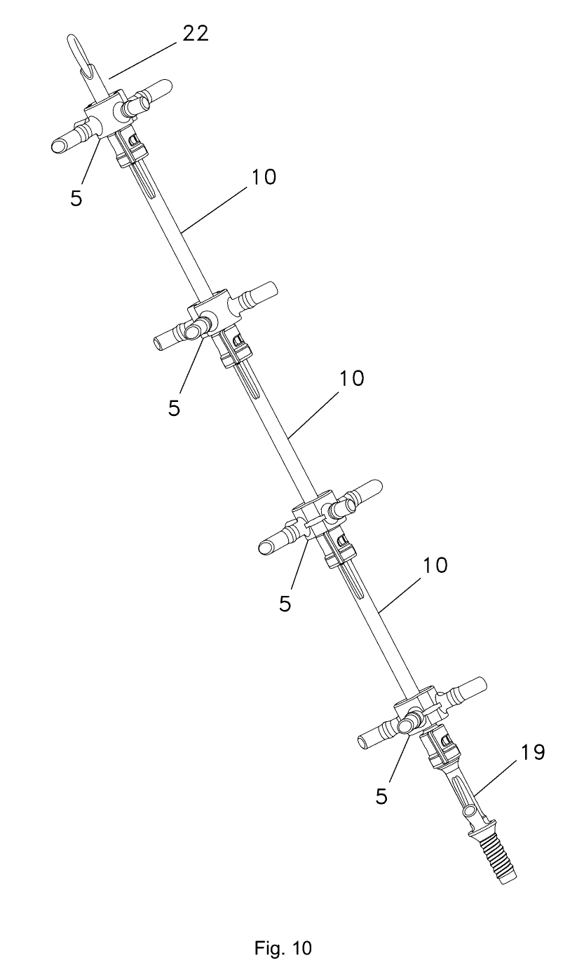

Generally referring to FIG. 1, in one embodiment the inventive technology may describe a modular balloon support system. In a preferred embodiment, this system may be configured to secure one or more balloons to a modular balloon support (1). In this preferred embodiment this modular balloon support (1) may include one or more connectors (10). As shown in FIGS. 6 and 10, in one embodiment a connector (10) may include an elongated connector (10) having a stem (17) which, as will be discussed in detail below, may be coupled with a manifold (3). Again, as specifically shown in FIG. 6, in this preferred embodiment, the connector (10) may include a proximal coupler position (11a) as well as a terminal coupler position (11b) that may be configured to be compatible one-with-another such that a plurality of connectors (10) may be coupled.

As specifically shown in FIGS. 1 and 6, in a preferred embodiment, a proximal coupler position (11a) may include at least one slide extension (12) configured to be capable of being coupled with a slide lock (13) on a terminal coupler position (11b). In this configuration, a plurality of connectors (10) may be coupled in series with the corresponding proximal coupler position (11a) being coupled with a corresponding terminal coupler position (11b). It should be noted that alternative embodiments are contemplated where such connectors may be coupled in a non-series configuration and, in fact, in some instances a single coupler position may be coupled with multiple connectors. Additional embodiments include multiple terminal and/or proximal coupler positions (11b, 11a) such that a plurality of connectors may be coupled together as generally described above while also allowing the connector (10) elements to be rotatable forming a customized modular shape or design of a connector (10) backbone.

In still other embodiments, a variety of coupler mechanisms may be contemplated. For example, both a proximal coupler position (11a) and a terminal coupler position (11b) may include coupler positions including, but not limited to: a slide lock coupler position; a snap lock coupler position; a fitted coupler position; a beveled coupler position; a twist lock coupler position; a threaded coupler position, a clamp lock coupler position; and a quick release coupler position. Each variety of coupler position may, as described above, allow a plurality of connectors (10), each having both a complementary proximal coupler position (11a) and a complementary terminal coupler position (11b) to be coupled in series or in another coupling configuration.

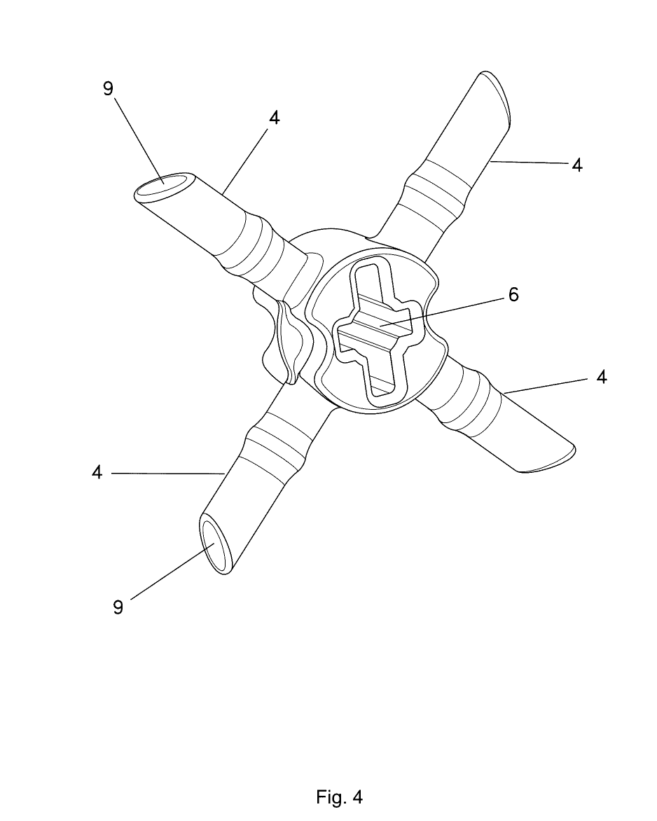

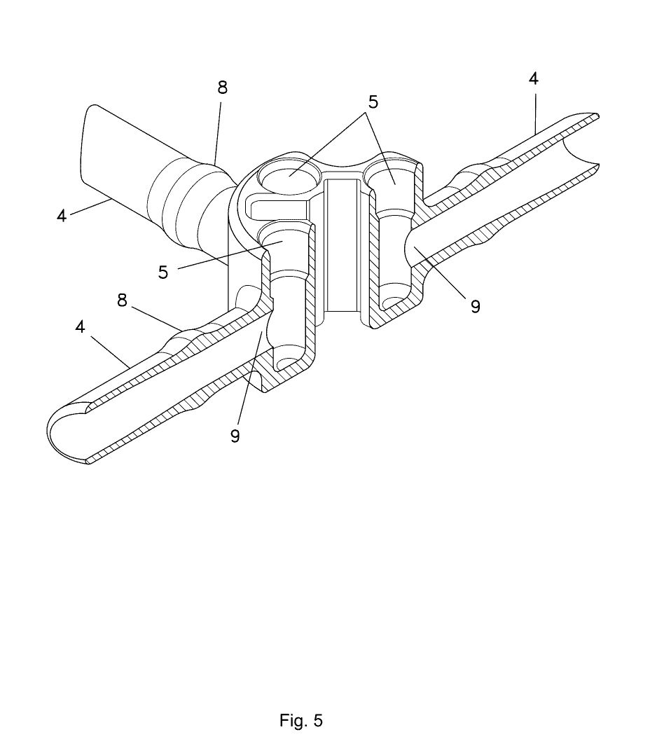

Referring now to FIGS. 1, and 4-5, in one embodiment a modular balloon support (1) may include a manifold (3). In one embodiment, a manifold (3) may be configured to be coupled with a connector (10). As shown in FIGS. 4-5, in this preferred embodiment, a manifold may include a manifold aperture (6). In some embodiments this manifold aperture (6) may be configured to allow a connector (10) to be inserted through it and thus coupling one or more manifolds (3) with the connector (10). In another embodiment shown in FIG. 6, one or more manifolds (3) may be configured to be slidably positioned over the stem (17) such that it may form a rotatable coupling which may allow the manifold (3) to rotate around the axis of the stem (17).

Again referring to FIG. 6, in one embodiment a manifold (3) may be configured to allow a connector (10), having one or more manifold catches (16) to be inserted through its manifold aperture (6). In this preferred embodiment the manifold (3) may be positioned over the stem (17) such that it may form a rotatable coupling which may allow the manifold (3) to rotate around the axis of the stem (17) and additionally, when the manifold (3) is positioned at the proximal end of a connector (10), which as shown in FIG. 6, this manifold aperture (6) may be positioned over one or more manifold catches (16). In this embodiment, when the manifold aperture (6) is secured over one or more manifold catches (16) the manifold may be secured such that it may no longer rotate. In this embodiment, where a plurality of connectors (10) is coupled, in this instance, in series, a plurality of manifolds (3) may be positioned over a corresponding connector (10). When, for example, this series of connectors (10) may be positioned with the proximal end facing down, the natural action of the manifold (3) may cause it to slide down the stem (17) and be coupled into a desired position through engagement with one or more manifold catches (16). In this embodiment, one or more manifold catches (16) may be positioned in different positions to permit pre-determined positioning of a manifold(s) (3). Naturally, as with all elements, such as balloon attachments (4), manifolds (3) and the like, manifold catches (16) may also be adjustable.

Again referring to FIG. 6, in one embodiment a connector (10) may include a manifold block (18). In a preferred embodiment, this manifold block (18) may be positioned approximate to the terminal coupler position (11b) such that when a manifold (3) is positioned over the stem (17) its natural action may allow it to slide down until it is mechanically stopped by the manifold block (18). In the preferred embodiment shown in FIG. 6, this manifold block (18) may include a planar surface such that when it engages with a manifold (3) it may still allow the manifold to rotate freely along the axis of the stem (17). It should be noted that while the figures demonstrate an embodiment having one or more manifold catches (16) at the proximal end of a connector (10) and the manifold block (18) at the terminal end, such positions may be switched as well as combined so the proximal, terminal or even both ends of a connector (10) may include one or more manifold catches (16), a manifold block (18) or both.

Referring now to FIG. 4, in one embodiment a manifold (3) may include one or more balloon attachments (4). In a preferred embodiment a manifold (3) may include one, or even a plurality of balloon attachments (4) that may be configured to be coupled with a balloon (2). While the embodiments shown in the figures demonstrates a manifold (3) having four balloon attachments (4), in certain other embodiments a manifold may have anywhere from 1 to even twenty or more balloon attachments (4). In still other embodiments such balloon attachments (4) may be configured to be secured to one or more plurality of balloons. Again referring to FIG. 4, in one embodiment a balloon attachment (4) may include a catch (8). In a preferred embodiment, this catch may include a structure configured to help secure or couple a balloon (2) to a balloon attachment (4). In the embodiment shown in FIG. 4, such a catch (8) may include an expanded surface that may be inserted into, for example, a balloon housing (41) or an integral external support housing as described in U.S. Pat. No. 9,132,595 (which is herein incorporated by reference), or a valve, a plug, or even a balloon support or coupler as described in U.S. patent application Ser. No. 14/743,839 (which is herein incorporated by reference). Alternative embodiments may include a threaded catch; a fitted catch; a slide catch; a snap catch; a beveled catch; and even a frictional surface catch. In addition, each balloon attachment (4) may include an airway (9) such that a balloon (2) may be secured with the balloon attachment (4) and may be inflated by passing air through the airway into the balloon (2). In some embodiments, such an airway (9) may connect a plurality of said balloon attachments such that multiple balloons may be internally inflated from a single air supply. Naturally, additional items may be coupled with a balloon attachment (4), such as marketing displays, signs, advertisements, placards and the like. Other embodiments may not include such an airway, however, in such embodiments one or more balloons (2) may be inflated externally through, for example, an inflation port (32).

It should be noted that a variety of balloons (2) may be configured to be secured to one or more balloon attachments (4). Such balloon embodiments may include traditional balloons, and helium-free balloons. Other embodiments include a rotationally molded helium-free and seam-welded helium-free balloon as described in U.S. Pat. No. 9,132,595, as well as blow-molded helium-free balloon as described in U.S. Pat. App. No. 62/199,720 (both of which are herein incorporated by reference).

Referring to FIGS. 1 and 4, in an alternative embodiment a manifold (3) may include one or more valve housings (5) securing one or more valves (7). In a preferred embodiment as shown in FIG. 5, a manifold (3) may include a valve housing (5) that may form an airway (9) with a balloon attachment (4). In this preferred embodiment, a valve (7) may be secured within a valve housing (5) such that air may pass through the valve (7) and into the valve housing (5) or airway (9) and eventually into a corresponding balloon (2). In this embodiment, each balloon attachment (4) may be paired with a corresponding valve housing (5) allowing each corresponding balloon (2) secured to a balloon attachment (4) to be internally inflated without requiring an inflation port (32) on the external surface of a balloon (2). In another embodiment, a single valve housing (5), securing perhaps a single valve (7) may be connected through one or more airways (9) with a plurality of balloon attachment (4) such that air passing through the valve (7) and into the valve housing (5) or airway (9) may be distributed into multiple balloon attachments (4) thereby inflating their corresponding balloon (2).

Naturally a variety of valves (7) maybe be incorporated into various embodiments of the invention. Such valves (7) may include, but not be limited to: a needle valve, a one-way valve; a two-way valve; a removable valve; a manual inflation valve; a compressed air inflation valve; and a plug valve or even a plug. Additional embodiments may include a valve housing (5) that is configured to be coupled with a compressed air valve or hose such that one or more balloons (2) may be inflated directly by such a machine cutting down on cost and time.

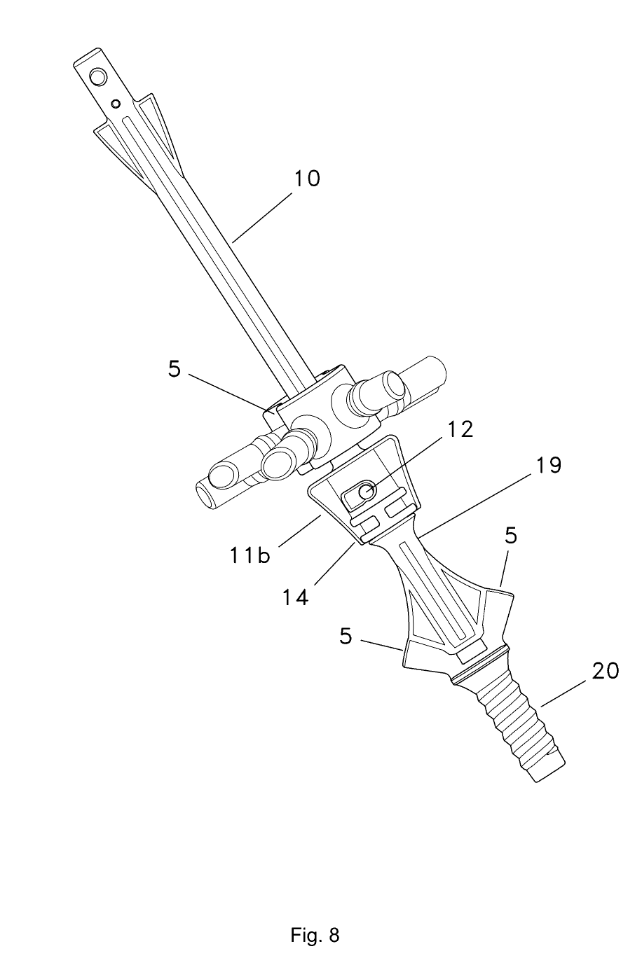

Referring to FIGS. 1 and 7-8, in one embodiment, the invention may include at least one terminal adaptor (19). In a preferred embodiment shown in FIG. 8, a terminal adaptor (19) may be coupled with a connector (10). In this example, the terminal adaptor (19) may have a coupler position (14) that may be configured to be coupled with a connector (10). In one embodiment, this coupler position (14) may include one or more slide extensions (12) that may correspond to, and couple with a slide lock (13) on the terminal coupler position (11b) of a connector (10). It should be noted that such configurations as it may apply to the coupling of any connector (10) or terminal adaptor (19) may include slide extensions (12) and/or slide locks (13) in reverse correspondence. In addition a variety of coupling mechanisms may be employed such as: a slide lock coupler position; a snap lock coupler position; a fitted coupler position; a beveled coupler position; a twist lock coupler position; a threaded coupler position, a clamp lock coupler position; and a quick release coupler position.

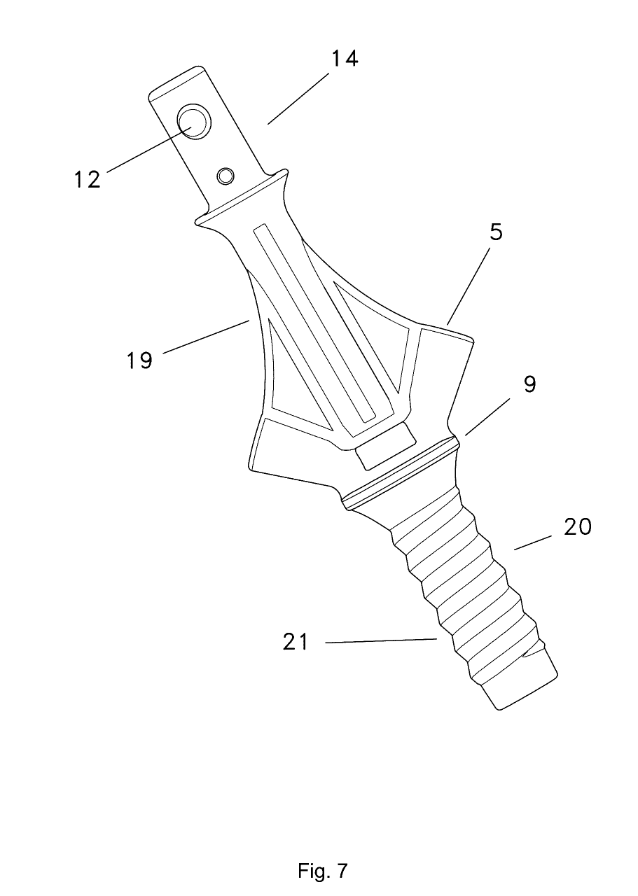

Referring again to FIG. 7, in one embodiment a terminal adaptor (19) may include a balloon attachment position (20). In a preferred embodiment this balloon attachment position (20) may be configured to be secured to a balloon housing (41) or an integral external support housing as described in U.S. Pat. No. 9,132,595 (which is herein incorporated by reference), or a valve, a plug, or even a balloon support or coupler as described in U.S. patent application Ser. No. 14/743,839 (which is herein incorporated by reference). In a preferred embodiment a terminal adaptor (19) may include a threaded attachment (21) as a balloon attachment position (20). In this embodiment, the threaded attachment (21) may be coupled with a corresponding balloon housing (41)—which may also be threaded—on an helium-free balloon. As shown in a preferred embodiment, this second balloon coupled with the threaded balloon housing (41) may be an oversized helium-free balloon. (It should be noted that for the purposes of this application the term oversized may include any balloon that is larger in size than a corresponding first balloon coupled with a balloon attachment (4) on a manifold (3)).

Referring again to FIGS. 1 and 7, in one embodiment the inventive technology may include a terminal adaptor (19) having one or more valve housings (5). In a preferred embodiment this valve housing (5) may form an airway (9) with a balloon attachment (4) on the terminal adaptor (19). In this preferred embodiment, a valve (7) may be secured within the terminal adaptor's (19) valve housing (5) such that air may pass through the valve (7) and into the valve housing (5) or airway (9) that connects the valve housing (5) and balloon attachment (4) position and eventually pass into, and inflate, a corresponding second balloon (2).

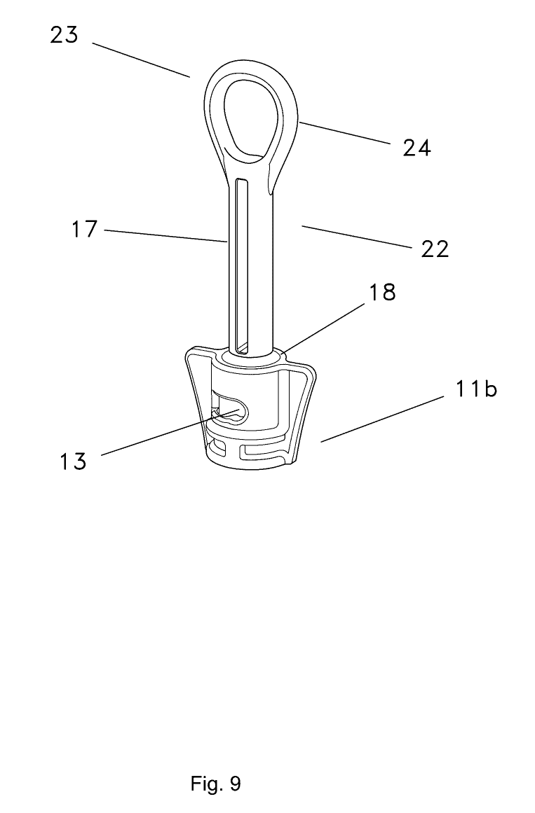

Referring now to FIGS. 1 and 9-10, in one embodiment the inventive technology may include at least one proximal adaptor (22). In a preferred embodiment, a proximal adaptor (22) may be coupled to one or more connectors (10). In one example, a proximal adaptor (22) may include a terminal coupler position (11b) which may be coupled with a proximal coupler position (11a) on one or more connectors (10). In the preferred embodiment shown in FIG. 10, the proximal coupler position (11a) on the proximal adaptor (22) may include a slide lock (15) which may be configured to be coupled with one or more slide extensions (12) on a connector (10). In another embodiment a proximal adaptor (22) may include both proximal and terminal coupler positions respectively (11a, 11b), either of which may be configured to secure or be coupled with a connector (10), terminal adaptor (19), external surface mount (34) or other external surface.

As shown in FIGS. 1 and 9-10, in one embodiment a proximal adaptor (22) may include one or more support coupler positions (23). In this embodiment, such a support coupler position (23) may allow the proximal adaptor (22)—as well as any other coupled elements, such as connectors (10) or terminal adaptors (19)—to be secured to an external surface, attachment, or external surface mount (34). In one preferred embodiment, a proximal adaptor (22) may have at least one surface attachment position (24). In this embodiment, this surface attachment position (24) may include a loop that may be secured to a hook or other hanging element. In another embodiment, this surface attachment position (24) may be coupled with a magnetic fitting display as described in U.S. patent application Ser. No. 14/931,631 (herein incorporated by reference) and secured to an elevated surface. Additional surface attachment positions (24) may include, but not be limited to: a stake attachment position, a stand attachment position, a pole attachment position, a loop attachment position, a magnet attachment position, a suction attachment position, a lock attachment position, a slide attachment position.

In another embodiment a proximal adaptor (22) may include a manifold block (18). In this preferred embodiment, this manifold block (18) may be positioned approximate to a terminal coupler position (11b) such that a proximal adaptor (22) may be inserted through a manifold aperture (6) thus positioning the manifold (3), in this instance, over the stem (17) of the proximal adaptor (22). The natural action of the manifold (3) may allow it to slide down until it is mechanically stopped by the manifold block (18). In the preferred embodiment shown in FIGS. 1 and 9-10, this manifold block (18) may include a planar surface such that when it engages with a manifold (3) it may still allow the manifold to rotate freely along the axis of the stem (17) of the proximal adaptor (22).

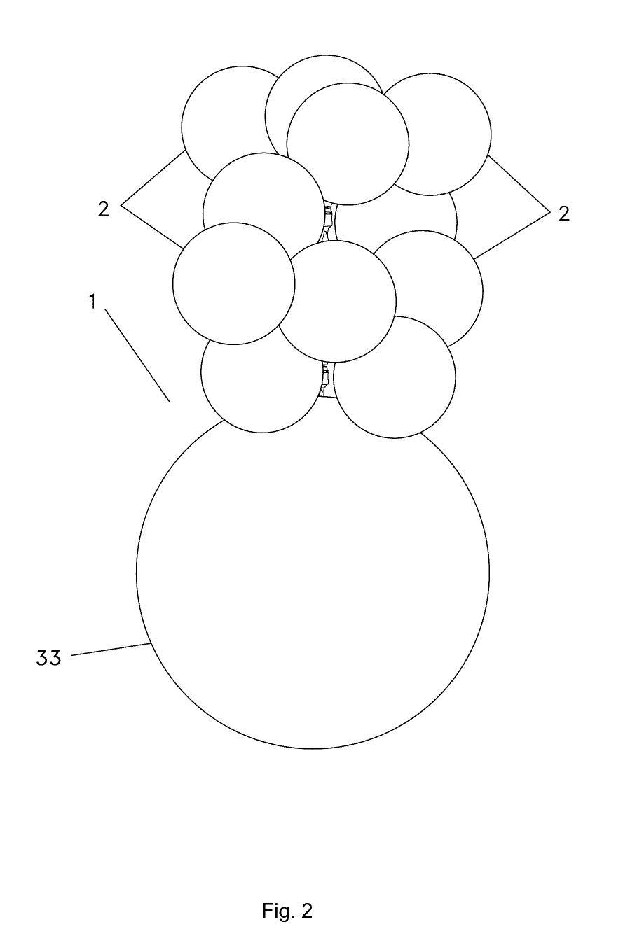

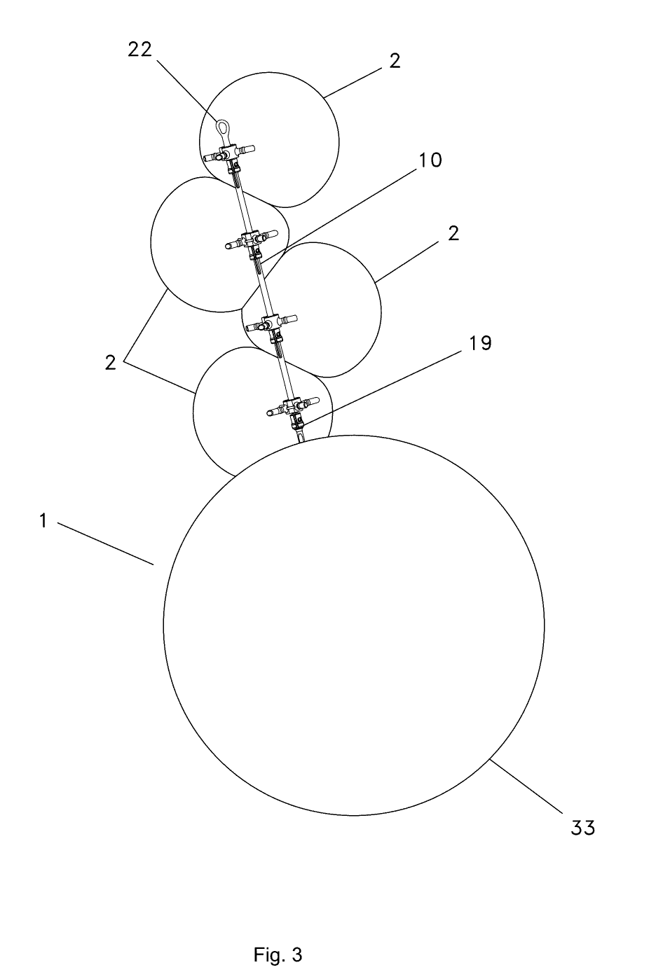

Now referring to FIGS. 1-3, in one preferred embodiment a plurality of connectors (10) may be coupled in series with a terminal adaptor (19) coupled in series with a connector (10) on one end, and a proximal adaptor (22) coupled in series with a connector (10) on the other. In this preferred embodiment, a plurality of manifolds (3) may be positioned over the stems (17) of each connector (10) as well as the terminal and a proximal adaptors respectively (19)(22) such that each manifold (3) may be freely rotatable. The manifold (3) may rotate around the axis of each stem (17). As shown in FIGS. 2-3, in this preferred embodiment a plurality of balloons (2), such as helium-free balloons may be secured to the balloon attachments (4) on each manifold (3) forming a spiral configuration of balloons (2) along the axis of the modular balloon support (1). Finally as also shown in FIGS. 2-3, in this preferred embodiment, a second balloon, such as an oversized helium-free balloon may be coupled with a balloon attachment position (20) on a terminal adaptor (19). In another alternative embodiment, a plurality of manifolds (3) may be coupled with a connector (10) such as a pole that may be positioned on a stand, suspended from an elevated position or staked into a surface such as the ground. In this embodiment, a pole may include a plurality of manifold coupler positions such as slide extensions, or even manifold blocks (18) that may allow the manifolds (3) to be spaced at pre-determined positions. In this embodiment, a plurality of balloons (2), such as helium-free balloons may be secured to the balloon attachments (5) on each manifold (3) forming a spiral or other configuration of balloons (2) along the axis of the pole. In some embodiments this pole may include a balloon attachment position (20) at one end that may secure, as described above, an oversized helium-free balloon, or other balloon, marketing display or even signage.

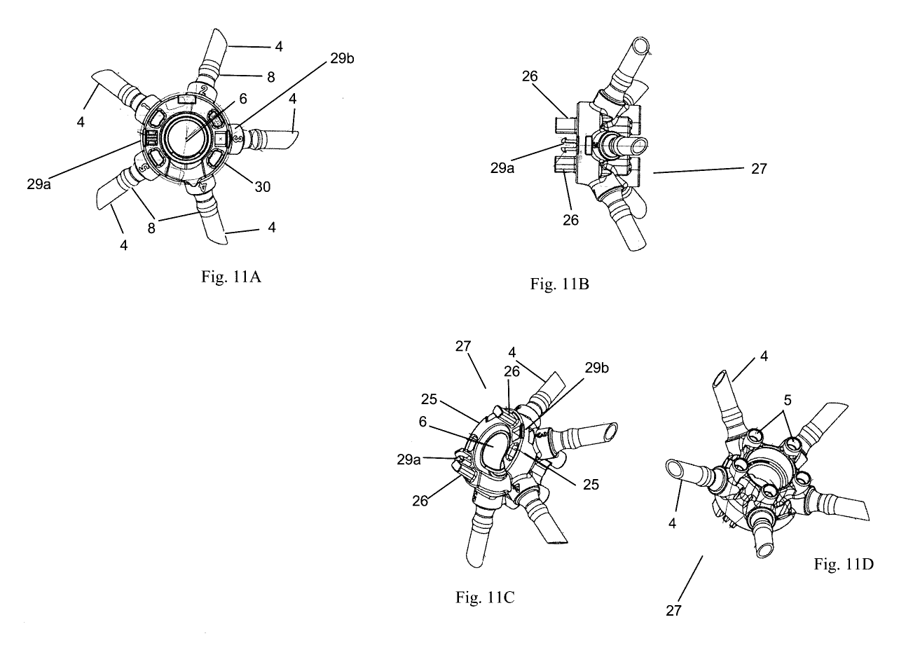

Referring to FIG. 11, in one embodiment the invention may include a modular manifold (27), which may in some embodiments be a manifold (5). In one preferred embodiment, a first modular manifold (27) having at least one balloon attachment (4) may be configured to be capable of coupling with at least one second manifold (27), which may also have one or more balloon attachments (4). In this preferred embodiment, the first and second manifolds (3) may be coupled through a manifold coupler (29a). In this embodiment, a manifold coupler (29a) on one or both manifolds (3) may be secured in a corresponding manifold coupler position (29b). As shown in FIG. 11, in a preferred embodiment, this manifold coupler (29a) may include a snap-lock configured to be inserted and locked into a corresponding manifold coupler position (29b). Naturally, a variety of manifold couplers (29) may be contemplated in the invention, including but not limited to: a slide manifold coupler position, a magnetic manifold coupler position, a fitted manifold coupler position, a beveled manifold coupler and even an adhesive manifold coupler position and the like.

In another preferred embodiment, one or both manifolds (3) may include one or more manifold slots (25) which may correspond one or more manifold guides (26), and in some instances may act to help guide and/or align both modular manifolds (27) prior to coupling. In this embodiment, the balloon attachments (4)—which in this case include five balloon attachments (4) angling outward from the modular manifold (27)—may be optimally positioned to form a desired “balloon cluster.” In other embodiments, both the manifold slots (25) and/or manifold guides (26) may also acts as a manifold coupler (29a) as described above.

As shown in FIG. 11, in one embodiment a modular manifold (27) may include a valve housing (5) which may further secure a valve (7) similar to the description above. In this preferred embodiment there may be one valve housing (5) and valve (7) per balloon attachment (4). In this embodiment, each valve housing may be connected to a balloon attachment (4) by an airway (9) such that a balloon (2) may be secured to a balloon attachment (4) and may be inflated by passing air through the valve (7) in the valve housing (5), and into the airway (9) and then into the balloon (2). In some embodiments a modular manifold (27) may include one valve housing (5) having perhaps one valve (7) connected with an airway (9) that may connect a plurality of balloon attachments (4) such that multiple balloons may be externally inflated from a single air supply.

In another embodiment an airway (9) may connect a plurality of balloon attachments (4) such that a balloon (2) may be secured to a balloon attachment (4) and may be inflated by passing air through an inflation port into the balloon (2) and into an airway (9) such that multiple balloons may be internally inflated from a single air supply.

It should be noted that in some embodiments one or more modular manifolds (27)—which may be coupled or uncoupled—may be secured to an external surface such as a wall, or elevated position, or even positioned on a pole or connector (10) or other elements as described above. In certain embodiments a modular manifold (27) may be configured to be magnetically coupled to an external surface, such as through an integrally positioned magnet in the manifold itself, or through an magnetic attachment or magnetic fitting display as described in U.S. patent application Ser. No. 14/931,631 (again, incorporated herein by reference). In another embodiment a modular manifold (27) may be configured to be suction coupled to an external surface, such as through an integrally positioned suction cup in the manifold itself, or through a suction cup attachment that may be coupled with a modular manifold (27).

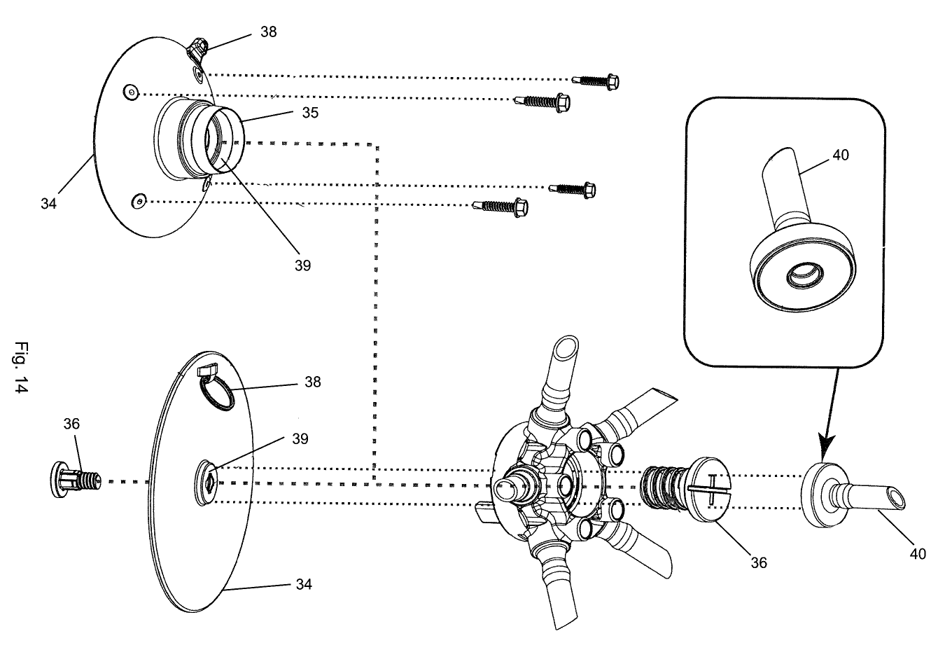

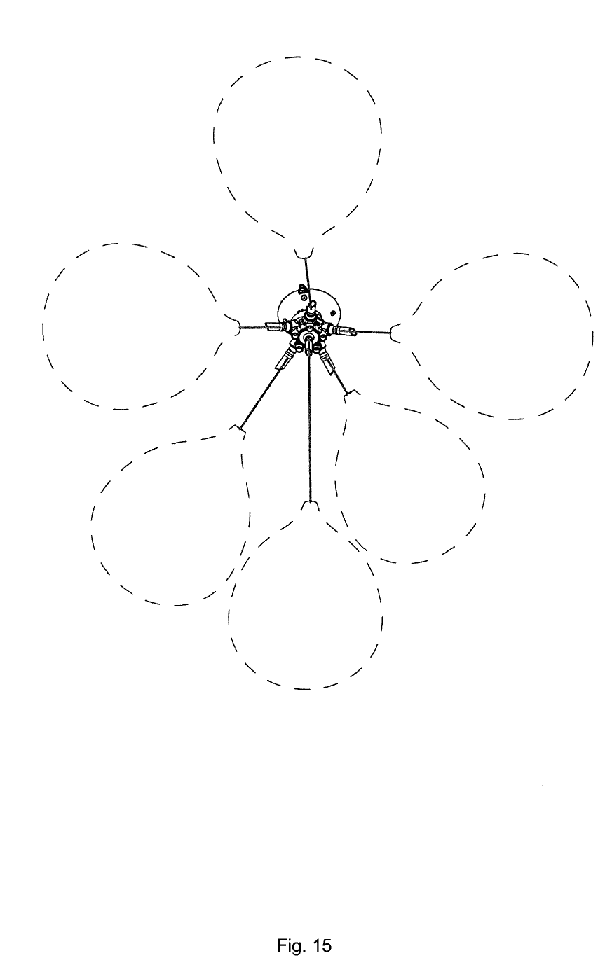

Referring to FIG. 14, in one embodiment a modular manifold (27)—as well as the manifold (3)—may include a manifold aperture on said manifold configured to be capable of securing at least one secondary balloon attachment (40). (It should be noted that a variety of secondary balloon attachments (40) are contemplated and described in this application.) Again, referring to FIG. 14, in a preferred embodiment, a modular manifold (27)—in this embodiment having five balloon attachments angling outward—may be coupled with an secondary balloon attachment (40) configured to be secured in a manifold aperture (6). In some embodiments this secondary balloon attachment (40) may be secured to a manifold aperture through a threaded coupling, a magnetic coupling, a fitted coupling and the like. In this embodiment a secondary balloon attachment (40) may be coupled with a manifold aperture (6) and may further be coupled with a balloon (2). In this configuration, as shown in FIG. 15, a modular manifold (27) may form an exemplary shaped balloon cluster.

Again, as shown in FIGS. 14-15, in one embodiment one or more modular manifolds (27)—or manifolds (3)—may be coupled with an external surface mount (34) which may further be coupled with a surface or other support. In one preferred embodiment, an external surface mount (34) may include a magnetic external surface mount (34). In this embodiment, a modular manifold (27) may be coupled with an magnetic external surface mount (34) through a manifold fastener (36). Additional embodiments may include a modular manifold (27) coupled with an surface mount (34) through a lock, adhesive surface or even magnetic coupling and the like. Again referring to FIG. 14, in this embodiment, a manifold fastener (36) may be positioned through a manifold aperture (6) on the modular manifold (27) and further secured to an external surface mount (34). In one preferred embodiment, one or more manifold fasteners (36) may be secured with a corresponding threaded manifold aperture (6) and external surface mount aperture (39) on the external surface mount (34). Additional coupling mechanisms may be encompassed in this invention, including a lock, snap lock, slide lock, fitted lock, an adhesive surface or even magnetic coupling and the like.

In addition, one or more manifold fasteners (36) may be coupled with an external surface mount aperture (39) first and then further coupled with a modular manifold (27). In this preferred embodiment, one or more modular manifolds (27) may be coupled with an external surface mount (34) secured to an external surface—such as a metal surface in the case of a magnetic external surface mount (34)—and may further be coupled with a plurality of balloons forming a desired “balloon cluster.” In yet another preferred embodiment, an second balloon may be secured to a secondary balloon attachment (40) which then may be secured to a modular manifold (27), for example through a manifold aperture (6), or even with an external surface mount (34) or manifold fastener (36). In this configuration, as demonstrated in FIGS. 14 and 15, the modular manifold (27) coupled with a secondary balloon attachment (40) may form an exemplary balloon cluster which also hides from view the external surface mount (34) and modular manifold (27).

In certain embodiments, this secondary balloon attachment (40) may be secured to a modular manifold (27), a manifold aperture (6), or even an external surface mount aperture (39). In one preferred embodiment it may be magnetically coupled with a manifold fastener (36). This secondary balloon attachment (40) may further include a valve housing (5) securing one or more valves (7). A surface disinterment handle (38) may also be secured with or configured to be coupled with an external surface mount (34) which may allow a user to grasp and/or remove an external surface mount (34) from a corresponding surface.

In another preferred embodiment, one or more modular manifolds (27) may be coupled with an external surface mount (34) which may be a suction cup that may further be secured to an external surface and may further be coupled with a plurality of balloons forming a desired “balloon cluster.” In one embodiment a manifold adaptor (35) on an external surface mount (34) may be coupled with a manifold aperture (6). As shown in shown in FIGS. 14-15, in this embodiment a threaded manifold adaptor (35) may be coupled with a corresponding threaded modular manifold (27). (Naturally additional mechanisms to secure a manifold to a manifold adaptor (35) may include a lock, a slid lock, a snap lock, a fitted lock, as well as a magnetic or adhesive lock.) In addition, a manifold fastener (36) may further be secured to the external surface mount (34). Again as shown in FIG. 14-15, a threaded manifold fastener (36) may be inserted through a manifold aperture (6) and threadably coupled with a corresponding threaded external surface mount aperture (39). Additional embodiments may include mounting elements such as screws that may be configured to secure an external surface mount (34) to a surface or other support.

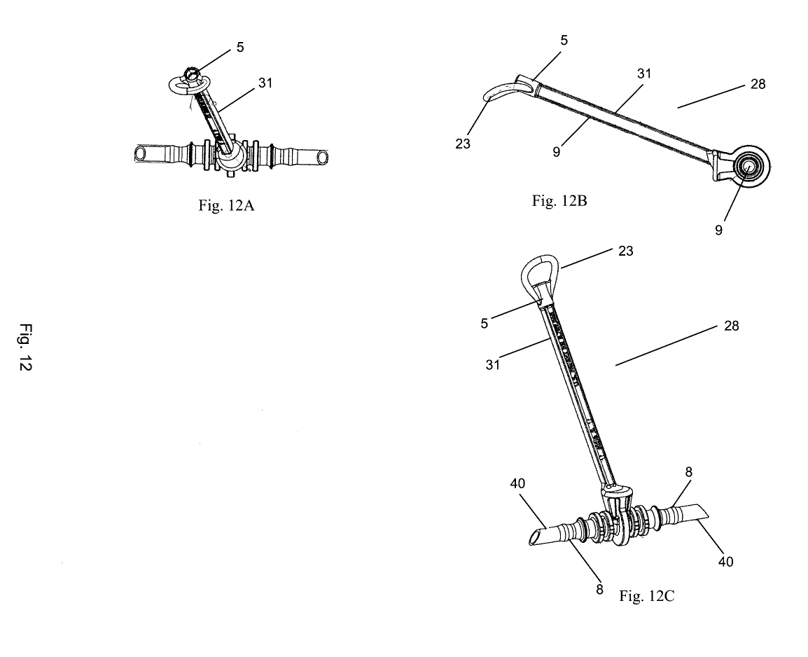

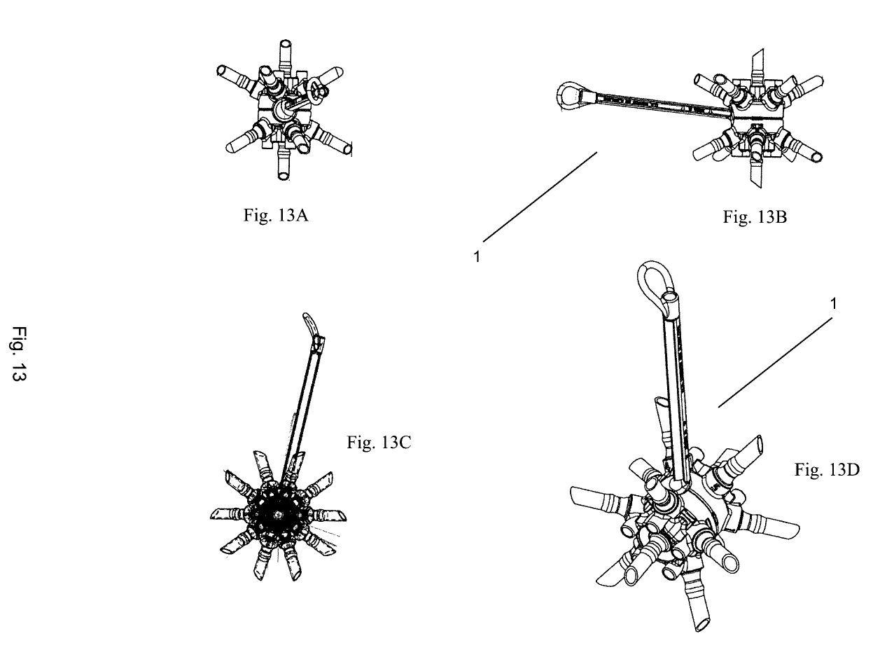

Referring to FIGS. 12-13, in one embodiment a plurality of modular manifolds (27) may be coupled with an extended modular manifold (28) forming a modular balloon cluster. In one embodiment, an extended modular manifold (28) may include one or more balloon attachments (4). Referring to FIG. 12, in one preferred embodiment an extended modular manifold (28) may include one or more secondary balloon attachments (40) coupled together. Each secondary balloon attachment (40) may be part of a unitary element or may configured to be separately coupled together. Again, as shown FIG. 2, in this embodiment two opposing secondary balloon attachments (40) may be coupled with an extended stem (31). As shown in FIG. 13, a modular manifold (27) may be configured to be inserted over each secondary balloon attachments (40). These modular manifolds (27) may then be coupled with one another as generally described above, thereby securing said extended modular manifold (28) within the coupled modular manifolds (27) forming a desired balloon cluster. In addition, referring back to FIG. 11, each modular manifold (27) may further include one or more extended modular manifold apertures (30) that may accommodate, for example the extended stem (31) of a corresponding extended modular manifold (28) when two or more modular manifolds (27) are coupled together.

As shown in FIG. 12, an extended modular manifold (28) may include one or more valve housings (5) which, as generally described above may secure a valve (7). Such a valve housing (5) may be connected with an airway (9) that may also connect with an airway (9) in one or more secondary balloon attachments (40). In this embodiment, air may pass through a valve (5) into a valve housing (7) and then may be directed through an airway (9) to one or more secondary balloon attachments (40) so as to internally inflate a coupled balloon (2). As also shown in FIGS. 12-13, in some embodiments an extended modular manifold (28) may include a support coupler position (23) which may function generally, as described above, to help secure the extended modular manifold (28)—along with any coupled modular manifolds (27) and corresponding balloons (2) to an external surface.

It should be noted that in some instances the various elements of the modular balloon support (1) have been described as unitary elements, such description is exemplary only as each element may also be separately detachable and/or re-attachable to any other element herein described.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, techniques as well as devices to accomplish a modular balloon support system. In this application, the methods and apparatus for the aforementioned systems are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system. In this application, the techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in method-oriented terminology, each element of the claims corresponds to a device. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “support” should be understood to encompass disclosure of the act of “supporting”—whether explicitly discussed or not—and, conversely, were there effectively disclosure of the act of “supporting”, such a disclosure should be understood to encompass disclosure of a “supporting method and/or technique, and/or device” and even a “means for supporting.” Such changes and alternative terms are to be understood to be explicitly included in the description.

Any patents, publications, or other references mentioned in this application for patent, such as in the specification or an IDS are hereby incorporated herein by reference in their entirety. Any priority case(s) claimed by this application is hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The Patent Application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the methods and/or apparatus for providing a modular balloon support system as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that this application also provides support for any combination of elements in the claims and even incorporates any desired proper antecedent basis for certain claim combinations such as with combinations of method, apparatus, process, and the like claims.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and Description (including the following: for example, the process according to any claims and further comprising any of the steps as shown in any Figures, separately, in any combination or permutation).

What is claimed is:

1-30. (canceled)

31. A modular balloon system comprising:
a plurality of connectors coupled together where each connector has a proximal coupler position and a terminal coupler position;
at least one manifold coupled with at least one connector;
at least one balloon attachment on said manifold;
at least one valve housing on said manifold;
at least one valve positioned within said valve housing;
at least one terminal adaptor coupled with at least one of said connectors;
at least one balloon attachment position on said terminal adaptor;
at least one balloon secured to each of said balloon attachments on said manifold; and
at least one second balloon secured to a balloon attachment position on said terminal adaptor.

32-42. (canceled)

43. A modular balloon system as described in claim 31 wherein said manifold comprises a manifold having an aperture configured to be slidably positioned over said connector forming a rotatable coupling.

44-53. (canceled)

54. A modular balloon system as described in claim 31 wherein said second balloon comprises a balloon selected from the group consisting of: a helium-free balloon; a rotationally molded helium-free balloon; a seam-welded helium-free balloon; and a blow-molded helium-free balloon.

55. A modular balloon system as described in claim 31 wherein said balloon comprises a balloon selected from the group consisting of: a helium-free balloon; a rotationally molded helium-free balloon; a seam-welded helium-free balloon; and a blow-molded helium-free balloon.

56. A modular balloon system as described in claim 54 wherein said second balloon comprises an oversized helium-free balloon.

57. A modular balloon system as described in claim 31 wherein said valve housing comprises at least one valve housing having an airway connecting said valve housing and said balloon attachment position.

58. A modular balloon system as described in claim 31 wherein said terminal adaptor having at least one balloon attachment position comprises a terminal adaptor having at least one valve housing.

59. A modular balloon system as described in claim 58 wherein said terminal adaptor comprises a terminal adaptor having at least one airway connecting said valve housing and said balloon attachment position.

60. A modular balloon system as described in claim 31 and further comprising at least one valve positioned within said valve housing of said terminal adaptor.

61-90. (canceled)

91. A balloon display comprising:
a plurality of connectors coupled in series;
at least one proximal adaptor coupled in series with at least one of said connectors;
at least one terminal adaptor coupled in series with at least one of said connectors;
at least one manifold rotatably coupled with at least one of said plurality of connectors;
a plurality of balloon attachments on said manifold;
at least one balloon attachment position on said terminal adaptor;
at least one helium-free balloon secured to each of said balloon attachments on said manifold; and
at least one second helium-free balloon secured to said balloon attachment position on said terminal adaptor.

92. A balloon display as described in claim 91 further comprising at least one valve housings on said manifold.

93. A balloon display as described in claim 92 further comprising at least one valve positioned within said valve housing on said manifold.

94. A balloon display as described in claim 91 further comprising at least one valve housing on said terminal adaptor.

95. A balloon display as described in claim 94 further comprising at least one valve positioned within said valve housing on said terminal adaptor.

96. A balloon display as described in claim 91 further comprising a plurality of balloon attachments on at least one of said manifolds which is rotatably coupled with said proximal adaptor.

97. A balloon display as described in claim 91 wherein said helium-free balloon comprises a balloon selected from the group consisting of: a rotationally molded helium-free balloon; a seam-welded helium-free balloon; and a blow-molded helium-free balloon.

98. A balloon display as described in claim 91 wherein said helium-free balloon comprises a balloon selected from the group consisting of: a rotationally molded helium-free balloon; a seam-welded helium-free balloon; a blow-molded helium-free balloon; and an oversized helium-free balloon.

99. A balloon display as described in claim 91 wherein said proximal adaptor comprises a proximal adaptor having at least one surface attachment position.

100. A balloon display as described in claim 99 wherein said surface attachment position comprises attachment position configured to be secured to an external surface.

101. A balloon display as described in claim 100 wherein said external surface comprises an external surface selected from the group consisting of: an elevated surface, the ground, a stand.

102. A balloon display as described in claim 96 and further comprising at least one manifold rotatably coupled with each of said plurality of connectors where said manifolds are positioned such that a plurality of helium-free balloons are positioned in a spiral configuration.

103-185. (canceled)

186. A modular balloon cluster comprising:
a first manifold having a manifold aperture configured to be capable of coupling with a second manifold having a manifold aperture;
at least one balloon attachment on said first and said second manifolds;
at least one balloon coupled with said balloon attachments;
at least one manifold coupler on said first manifold configured to be capable of coupling with a manifold coupler position on said second manifold;
at least one secondary balloon attachment configured to be secured with said first or said second manifold aperture;
at least one valve housing on said manifold;
at least one valve positioned within said valve housing;
at least one airway connecting said valve housing and said balloon attachment.

187-193. (canceled)

194. A modular balloon cluster as described in claim 186 further comprising at least one manifold aperture on either said first or said second manifold configured to be capable of securing at least one secondary balloon attachment.

195. A modular balloon cluster as described in claim 194 wherein said secondary balloon attachment comprises a secondary balloon attachment selected from the group consisting of: a threaded secondary balloon attachment, a slide locking secondary balloon attachment, a fitted secondary balloon attachment, and a snap locking secondary balloon attachment.

196. A modular balloon cluster as described in claim 194 wherein said secondary balloon attachment comprises a secondary balloon attachment configured to be coupled with a manifold fastener.

197. A modular balloon cluster as described in claim 194 wherein said secondary balloon attachment comprises a secondary balloon attachment configured to be coupled with said manifold aperture on either said first or said second manifold.

198. A modular balloon cluster as described in claim 194 wherein said secondary balloon attachment comprises a valve housing.

199. A modular balloon cluster as described in claim 198 wherein said valve housing comprises a valve housing coupled with a valve.

200. (canceled)

201. A modular balloon cluster as described in claim 186 further comprising at least one external surface mount configured to be coupled with on either said first or said second manifold.

202. A modular balloon cluster as described in claim 201 wherein said external surface mount comprises a manifold adaptor and external surface mount aperture.

203. A modular balloon cluster as described in claim 202 wherein said manifold adaptor comprises a manifold adaptor selected from the group consisting of: an externally threaded manifold adaptor, and an internally threaded manifold adaptor.

204. A modular balloon cluster as described in claim 201 wherein said external surface mount comprises an external surface mount selected from the group consisting of: a magnetic external surface mount, a suction external surface mount, and a flexible laminated magnet adhered to a metal plate.

205. A modular balloon cluster as described in claim 194 wherein said secondary balloon attachment comprises a extended modular manifold.

206. A modular balloon cluster as described in claim 194 wherein said secondary balloon attachment comprises a secondary balloon attachment configured to be coupled with said manifold aperture.

207. (canceled)

208. An integrated multi-directional modular balloon cluster comprising:
a first manifold configured to be capable of coupling with a second manifold and forming a manifold aperture and an extended modular manifold aperture;
at least one balloon attachment on said first and said second manifolds;
at least one manifold coupler on said first manifold configured to be capable of coupling with a coupler position on said second manifold;
at least one extended modular manifold having:
at least one secondary balloon attachment configured to be positioned within said manifold aperture; and
at least one extended stem configured to be positioned within said extended modular manifold aperture;
at least one balloon coupled with said balloon attachments;
at least one valve housing on said manifold;
at least one valve housing on said extended modular manifold;
at least one valve positioned within said valve housings; and
at least one airway connecting said valve housings and said balloon attachments.

209. An integrated multi-directional modular balloon cluster as described in claim 208 further comprising at least one manifold slot.

210. An integrated multi-directional modular balloon cluster as described in claim 208 further comprising at least one manifold guide.

211. An integrated multi-directional modular balloon cluster as described in claim 208 wherein said extended modular manifold comprises a support coupler position.

212. An integrated multi-directional modular balloon cluster as described in claim 208 wherein said manifold coupler comprises a manifold coupler selected from the group consisting of: snap lock manifold coupler, slide lock manifold coupler, a magnetic manifold coupler, a fitted manifold coupler, and a beveled manifold coupler.

213. An integrated multi-directional modular balloon cluster as described in claim 208 wherein said first and said second manifolds comprises a first and said second manifold having a plurality of balloon attachments.

214-232. (canceled)
